(19) United States
(12) Patent Application Publication
(10) Pub. No.: US 2007/0259978 A1
(43) Pub. Date: Nov. 8, 2007

(54) Proton Exchange Composite Membrane with Low Resistance and Preparation Thereof

(75) Inventors: Hsiu-Li Lin, Taoyuan (TW); Leon Tzyy-Lung Yu, Taoyuan (TW); Wei-Kai Chang, Taoyuan (TW); Chien-Pang Cheng, Taoyuan (TW); Chih-Ren Hu, Taoyuan (TW); Chih-Hao Chiu, Taoyuan (TW); Shih-Hung Chan, Taoyuan (TW)

Correspondence Address: WPAT, PC;INTELLECTUAL PROPERTY ATTORNEYS, 2030 MAIN STREET, SUITE 1300, IRVINE, CA, 92614, US

(73) Assignee: YUAN ZE UNIVERSITY, Taoyuan (TW)

(21) Appl. No.: 11/616,819

(22) Filed: Dec. 27, 2006

(30) Foreign Application Priority Data
May 2, 2006 (TW) 095115639

(51) Int. Cl. C08J 5/22

(52) U.S. Cl. 521/27

(57) ABSTRACT

The present invention provides a proton exchange composite membrane with low resistance and preparation thereof. The present invention also provides a novel coupling agent.

### FIELD OF THE INVENTION

The present invention relates to a proton exchange composite membrane with low resistance and preparation thereof. The present invention also relates to a coupling agent for preparing the composite membrane of the present invention.

### BACKGROUND OF THE INVENTION

Nowadays, perfluorinated sulfonic acid ionomer (PFSI) is generally used in the preparation of membrane electrode assembly (MEA) for polyeletrolyte membrane fuel cells (PEMFC) and direct methanol fuel cells (DMFC) operated at temperatures below 100° C. The advantages of PFSI proton exchange membrane are: excellent mechanical properties, high chemical stability, high degradation temperature (above 280° C.), and high proton conductivity. The drawbacks of those included: (1) power efficiency is reduced by methanol crossover the membrane; (2) at operating temperatures above 100° C., proton conductivity drops due to the evaporation and loss of water contained in the membrane; (3) the cost of those is expensive.

Recently, many hydrocarbon polymers have been developed for proton exchange membranes used in PEMFC. Those polymers include PBI (polybenzimidazole), refer to U.S. Pat. No. 5,091,087; S-PEEK (sulfonated poly(arylether ether ketone)), refer to U.S. Pat. No. 6,632,847; S-PES (sulfonated poly(ethersulfone)), refer to Genova P. D. et. al., J. Membr. Sci., 185, p. 59 (2001); sulfonated poly(phenoxy phosphazene), refer to Guo Q. et. al., J. Membr. Sci., 154, p. 175 (1999); their derivatives, refer to Rikukawa M. and Sanui K., Prog. Polym. Sci., 25, p. 1463 (2000); and blends of them.

Increasing conductivity of membrane is one of the methods to improve the efficiency of the fuel cells. The reduction of the thickness of the membrane to reduce the resistance of the proton exchange membrane is another one. Recently, the low thickness (˜20 mm) Nafion-PTFE composite membranes had been prepared by immersing porous PTFE (polytetrafluoroethylene) membrane in Nafion (a trade name of PFSI of Du Pont Co) resin solutions, such as U.S. Pat. No. 5,834,523. Because of excellent mechanical strength of porous PTFE, the reinforcement of Nafion by porous PTFE improved the mechanical strength of the membranes. Thus we can reduce the thickness of proton exchange membranes and the Nafion-PTFE composite membranes have good mechanical strength in spite of their thicknesses of ˜20 μm. The thicknesses of Nafion 112, Nafion 115, and Nafion 117 membranes provided by DuPont Co are 50, 125, and 175 μm, respectively, which are thicker than Nafion-PTFE composite membranes used in PEMFC. Although the conductivity of Nafion-PTFE composite membrane is lower than that of commercial Nafion membranes, the performance of fuel cells prepared from Nafion-PTFE composite membranes is better than those prepared from commercial Nafion membranes due to the lower thickness and thus a lower resistance of Nafion-PTFE membranes, refer to Liu F. et. al., J. Membr. Sci., 212, p. 213 (2003); Shim J. et. al., J. Power Source, 109, p. 412 (2002); Lin H. L. et. al., J. of Membr. Sci., 237, p. 1 (2004). It is known that PTFE is a good barrier of methanol. Although the thickness of Nafion-PTFE membrane (thickness ˜20 mm) is thinner than Nafion 117 (thickness ˜175 mm), the methanol crossover of Nafion-PTFE membrane is lower than that of Nafion-117. The Nafion-PTFE has better performance than Nafion-117 in DMFC applications. Please refer to Lin H. L. et. al., J. Power Sources, 150, p. 11 (2005).

Because of poor compatibility of hydrocarbon polymer with PTFE, it is difficult to prepare hydrocarbon polymer-PTFE composite membranes having good bonding property between hydrocarbon polymers and porous PTFE membrane. There is no report directed to the fabrication of the hydrocarbon polymer-PTFE composite membranes.

### BRIEF DESCRIPTION OF THE DRAWINGS

FIG. 1(a) shows the scheme of the membrane of fluorocarbon based polymer having a porous microstructure (such as porous PTFE); it is used as a supporting material of composite membranes.

FIG. 1(b) shows the scheme of porous coupling agent-PTFE membrane, which is a porous PTFE membrane covered with a thin film of coupling agent and the porous microstructures are visible. The membrane was prepared by fabricating a thin film of coupling agent containing acidic functional groups on the surface of porous PTFE, and the amount of coupling agent is just high enough to cover the surface of microstructures of porous PTFE.

FIG. 1(c) shows the scheme of hydrocarbon polymer-PTFE composite membrane, in which the porous micro-structures (as shown in FIG. 1(b)) were filled with hydrocarbon polymers. It was prepared by fabricating a hydrocarbon polymer containing basic functional groups on the surface of a porous coupling agent-PTFE membrane (as shown in FIG. 1(b)).

FIG. 2 shows a SEM micrograph, at a magnification of 5000×, of a PTFE membrane without treating with a coupling agent.

FIG. 3 shows a SEM micrograph, at a magnification of 5000×, of a PBI-PTFE-0 composite membrane, which was prepared by impregnating porous PTFE directly in a PBI/DMAc solution without pre-treating with a coupling agent.

FIG. 4 shows a SEM micrograph, at a magnification of 5000×, of a porous PTFE membrane after treating with a coupling agent of 0.7 wt % Nafion solution.

FIG. 5 shows a SEM micrograph, at a magnification of 5000×, of a PBI-PTFE-19 composite membrane, which was prepared by fabricating PBI on the surface of porous coupling agent-PTFE membrane, which is same membrane as shown in FIG. 4.

FIG. 6 shows an instrument of measuring the gas permeability of membranes. In this Figure, 1 means valve; 2 means valve; 3 means valve; 4 means gas pressure gauge; 5 means gas pressure gauge; 6 means membrane holder; 7 means gas flow meter; 8 means vessel-1; 9 means vessel-2; 10 means pump and 11 means N₂ gas.

FIG. 7 shows a graph showing PEMFC voltage versus current density curves of MEAs prepared from PBI-100 (thickness=100 μm) and PBI-PTFE-22 (thickness=22 μm) and operated at various temperatures. (⋄) PBI-100 at 150° C.; (Δ) PBI-100 at 180° C.; (♦) PBI-PTFE-22 at 150° C.; (▴) PBI-PTFE-22 at 180° C. H₂ and O₂ flow rates were 300 ml/min.

FIG. 8 shows a graph showing PEMFC voltage versus current density curves of MEAs prepared from Nafion-117, PBI-80, PBI-PTFE-22, and PBI-PTFE-17 and operated at 70° C. (⋄) Nafion-117 (thickness=175 μm) (∘) PBI-80 (thickness=80 μm); ( [symbol] ) PBI-PTFE-22 (thickness=22 μm); (□) PBI-PTFE-17 (thickness=17 μm). H₂ and O₂ flow rates were 200 ml/min.

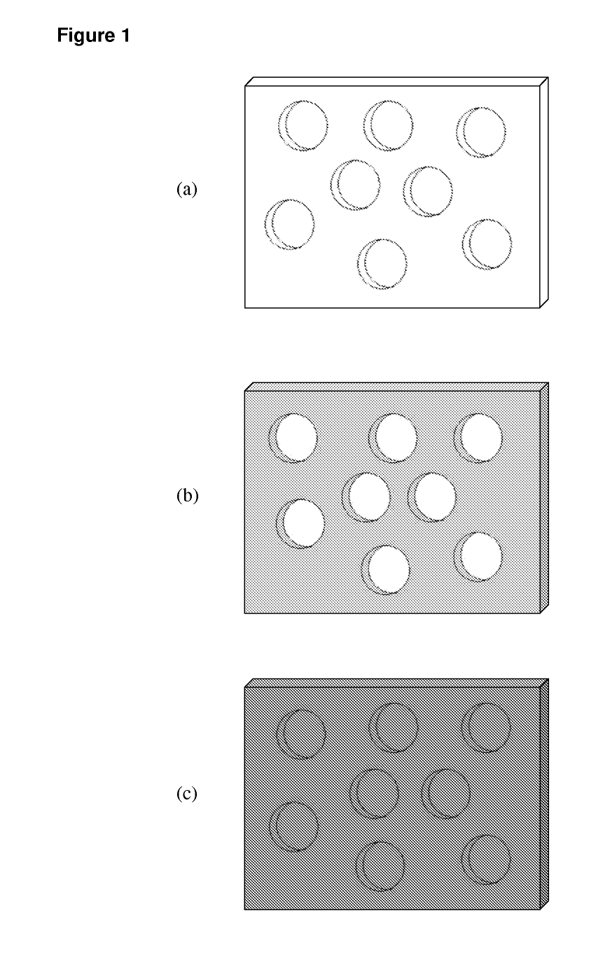

### SUMMARY OF THE INVENTION

The present invention provides a method for preparing a proton exchange composite membrane with low resistance, the method comprises:
(a) providing a fluorocarbon based polymer membrane having porous structure as a supporting material and a coupling agent consisting of fluorocarbon backbone and acidic functional groups, wherein the fluorocarbon backbone is compatible with the membrane and the acidic functional group is compatible with a polymer containing basic functional groups; and,
(b) treating the porous supporting membrane with the coupling agent solution to form a thin film of coupling agent on the surface of porous membrane.

The present invention also provides a proton exchange composite membrane with low resistance which comprises:
(a) a fluorocarbon based polymer membrane having porous structure as a supporting material; and
(b) a coupling agent consisting of fluorocarbon backbone and an acidic functional groups, wherein the fluorocarbon backbone is compatible with the membrane and the acidic functional groups are compatible with a polymer containing basic functional groups.

The present invention further provides a coupling agent which consists of a fluorocarbon backbone and acidic functional groups, wherein the fluorocarbon backbone is compatible with a fluorocarbon based polymer supporting membrane having porous structure and the acidic functional group is compatible with a polymer containing basic functional groups.

### DETAILED DESCRIPTION OF THE INVENTION

The present invention provides a method for the preparation of composite membranes composed of porous PTFE and hydrocarbon polymers containing basic functional groups. The membranes possess low resistance and low thickness. The coupling agent is used as an interface bonding agent between PTFE and hydrocarbon polymer. The coupling agent composes of fluorocarbon and acidic functional groups, which are compatible with porous PTFE and hydrocarbon polymers containing basic functional groups. The presence of coupling agent between the interface of PTFE and hydrocarbon polymer causes excellent bonding property of hydrocarbon polymer with porous PTFE supporting material.

Accordingly, the present invention provides a method for preparing of a proton exchange composite membrane with low resistance, the method comprises:
(a) providing a fluorocarbon based polymer membrane having porous structure and a coupling agent consisting of fluorocarbon backbone and acidic functional groups, wherein the fluorocarbon backbone is compatible with porous PTFE membrane and the acidic functional group is compatible with a polymer containing basic functional groups; and
(b) treating the porous PTFE membrane with the coupling agent solution to form a thin film of coupling agent on the surface of porous PTFE membrane.

In the preferred embodiment, the method of the present invention further comprises step (c): treating the membrane prepared by step (b) of the method of the present invention with the polymer containing a basic functional group.

In the preferred embodiment, the method of the present invention further comprises step (d): immersing the membrane prepared by step (c) of the method of the present invention in an acidic solution (such as sulfuric acid or phosphoric acid) to increase ionic conductivity.

In the preferred embodiment, the fluorocarbon based polymer membrane having porous structure could be immersed in acetone before the treatment.

The term “polymer containing basic functional group” is not limited but to a non-fluorocarbon based polymer selected from the group consisting of polyamide, polyimide, chitosan, and polybenzimidazole, preferably polybenzimidazole. In the polymer, the basic functional group is not limited but to select from the group consisting of —NH, —NH₂ or —OH group, preferably —NH group.

As to the material of the supporting membrane, the porous fluorocarbon based polymer membrane is PTFE membrane. The method of fabricating coupling agent on porous PTFE membrane is: immersion, screen printing, spin coating, brushing, or coating with a film applicator. In a preferred embodiment, the fabricating method is: immersion, brushing, or coating with a film applicator. In the preferred embodiment, the method of fabricating coupling agent on porous PTFE membrane is immersion.

The method of fabricating a polymer containing basic functional groups on a porous PTFE membrane containing coupling agent on its surface is: immersion, screen printing, spin coating, brushing, or coating with a film applicator. In a preferred embodiment, the fabricating method is: immersion, screen printing, brushing, or coating with a film applicator. In the most preferred embodiment, the fabricating method is coating with a film applicator. The thickness of porous membrane is between 12 μm and 30 μm. In a preferred embodiment, the thickness is between 15 μm and 25 μm. In the most preferred embodiment, the thickness is 16˜18 μm.

The present invention also provides a proton exchange composite membrane with low resistance which comprises:
(a) a fluorocarbon based polymer membrane having porous structure as a supporting material; and
(b) a coupling agent consisting of fluorocarbon backbone and an acidic functional groups, wherein the fluorocarbon backbone is compatible with the membrane and the acidic functional groups are compatible with a polymer containing basic functional groups.

In the preferred embodiment, the membrane of the present invention further comprises (c) a polymer with basic functional groups.

In the preferred embodiment, the membrane of the present invention further comprises: (c) a polymer with basic functional groups and (d) an acidic compound (such as sulfuric acid or phosphoric acid).

The membrane of the present invention, wherein the acidic compound is sulfuric acid or phosphoric acid and the coupling agent is used as an interface bonding agent between porous fluorocarbon based polymer membrane and polymers with basic functional groups.

The thickness of membrane is between 15 μm and 30 μm. In a preferred embodiment, the thickness of membrane is between 18 μm and 25 μm. In the most preferred embodiment, the thickness of membrane is ˜22 μm.

The membrane can be applied to fuel cells and electrolytic reaction. In a preferred embodiment, the membrane can be applied to fuel cells.

The present invention further provides a coupling agent which consists of a fluorocarbon backbone and acidic functional groups, wherein the fluorocarbon backbone is compatible with a fluorocarbon based polymer membrane having porous structure and the acidic functional groups are compatible with a polymer containing basic functional groups.

The coupling agent with dual chemical functional structures, one is compatible with fluorocarbon of porous supporting membrane and the other is compatible with basic functional groups (such as NH, NH₂, and OH) of a polymer, is used as an interface bonding agent between porous fluorocarbon based polymer and polymer having basic functional group. The porous PTFE substrate is impregnated with a diluted PFSI coupling solution. The optimum concentration of a coupling agent solution is that it is just high enough to cover the surface of the fibers of porous PTFE substrate membranes. The porous PTFE membrane after treating with a PFSI coupling agent solution was then impregnated in a PBI solution to prepare PBI-PTFE composite membrane. The PFSI coupling agent composes of fluorocarbon based backbone, which is compatible with PTFE, and ether fluorocarbon sulfonic acid side chains, which is compatible with —NH group of PBI. Thus a good bonding between PTFE and PBI can be obtained.

In the preferred embodiment, the coupling agent is perfluorosulfonate resin or perfluorocarbonate resin. In a more preferred embodiment, the coupling agent is perfluorosulfonic acid resin.

The coupling agent is soluble in organic or aqueous solvents and is prepared in a solution form when it is fabricated on a porous membrane. In a preferred embodiment, The solvent is DMAc (N,N′-dimethylacetamide), DMF (N,N′-dimethylformamide), NMF (N-methylformamide), methanol, ethanol, propanol, glycol, water, or mixtures of them. In a preferred embodiment, the solvent is DMAc, ethanol, propanol, water, or mixtures of them. In the most preferred embodiment, the solvent is a mixture of propanol and water.

In the present invention, an acidic functional group of coupling agents is not limited but to —SO₃H or —COOH group. In a preferred embodiment, the acidic functional group is —SO₃H. The concentration of a coupling agent solution is between 0.005 wt % to 10 wt %. In a preferred embodiment, the concentration is between 0.01 wt % to 5.0 wt %. In the most preferred embodiment, the concentration is between 0.05 wt % to 2.0 wt %.

The coupling agents used in the present invention composed of acidic functional groups, such as —SO₃H and —COOH, which are compatible with PBI, as well as perfluorocarbon (—CF₂—CF₂—) main chain, which is compatible with PTFE. It is known that PFSI resin composes of perfluorocarbon (—CF₂—CF₂—) main chains, and ether fluorocarbon sulfonic acid (—OCF₂—CF₂(CF₃)—OCF₂—CF₂—OSO₃H) side chains. The side chain —OSO₃H groups of PFSI may react with —NH groups of PBI and forms ionic bonds. Thus PFSI acted as a coupling agent of PBI and PTFE, and PBI was well bonded to PTFE after the surface of PTFE was treated with a thin film of PFSI resin. Thus, PFSI is a good coupling agent in the present invention.

### EXAMPLE

The following examples and related experimental data were intended to be merely exemplary and in no way intended to be limitative of the present invention.

### Preparation of PBI Membranes

2 wt % of PBI/LiCl/DMAc (N,N′-dimethyl acetamide) solution was prepared by dissolving 10 g PBI and 15 g LiCl in 500 ml DMAc under nitrogen atmosphere at 150° C. The DMAc solvent was then evaporated from the solution at 80° C. under vacuum to obtain a solution with a PBI content of around 8 wt %. The PBI solution was coated on a glass plate using a film applicator with a gate thickness of 100 μm˜130 μm. The glass plate with a thin film of PBI solution was heated at 80° C. for 1 hr and then 120° C. for 5 hr under vacuum to remove DMAc solvent. The PBI membrane was then immersed in distilled water for 3 days and the water was changed each day to remove LiCl. Finally, the PBI membrane was immersed in 85 wt % phosphoric acid solution for 3 days. The final thickness of PBI membrane was around 80 μm˜100 μm. Table 1 lists the thicknesses and phosphoric acid contents of two PBI membranes.

### Preparation of PBI/PTFE Composite Membranes

The solvent of as received PFSI solution was evaporated under vacuum at 60° C. and the residual solid PFSI resin was mixed with 2-propanol/water (4/1 wt ratio) mixture solvent to a solution containing 0.7 wt % of PFSI. Porous PTFE membrane was mounted on a 12×12 cm² steel frames and boiled in acetone at 55° C. for 1 hr. This pretreated PTFE membrane was then impregnated with a 0.7 wt % PFSI solution for 24 hr. These impregnated membranes were then annealed at 130° C. for 1 hr. After annealing, the membrane was then swollen with distilled water for 24 hr. Thus the porous PTFE membrane was coated on its surface with a thin film of PFSI. The porous PTFE membrane after coated with a thin film of PFSI was impregnated in a PBI/LiCl/DMAc (4.5/4.5/100 in wt ratio) solution for 5 min; the membrane was then heated at 80° C. for 30 min and then 120° C. for 30 min under vacuum. The process of impregnation in PBI/LiCl/DMAc solution and annealing was repeated for 3˜5 times to obtain a composite membrane with a desired film thickness. The PBI-PTFE composite membrane was then immersed in distilled water for 3 days and the water was changed each day to remove LiCl. Finally, the PBI-PTFE composite membrane was immersed in 85 wt % phosphoric acid for 3 days. Table 1 lists the final compositions and film thicknesses of PBI-PTFE composite membranes. The membrane acid-doping levels were determined by titrating a pre-weighed piece of sample with standardized sodium hydroxide solution.

TABLE 1
Compositions and film thickness of membranes

| | | | coupling | phosphoric | |
|---|---|---|---|---|---|
| | PBI | PTFE | agent | acid (g/100 g | thickness |
| # membrane | (wt %) | (wt %) | (wt %) | membrane) | (μm) |
| PBI-PTFE-22 | 51.7 | 47.6 | 0.7 | 18.0 | 22 + 3 |
| PBI-PTFE-19 | 49.4 | 49.9 | 0.7 | 15.4 | 19 + 2 |
| PBI-PTFE-17 | 47.2 | 52.1 | 0.7 | 14.5 | 17 + 1 |
| PBI-PTFE-0 | 40.7 | 59.3 | 0.0 | *** | 16 + 2 |
| PBI-100 | 100.0 | *** | *** | 38.0 | 100 + 2 |
| PBI-80 | 100.0 | *** | *** | 38.0 | 80 + 2 |

### Scanning Electron Microscopy (SEM) Observations

The morphology of the surface of membranes were investigated using a scanning electron microscope (SEM, model JSM-5600, Jeol Co., Japan). The sample surface was coated with gold powder under vacuum before the morphology of membranes was observed.

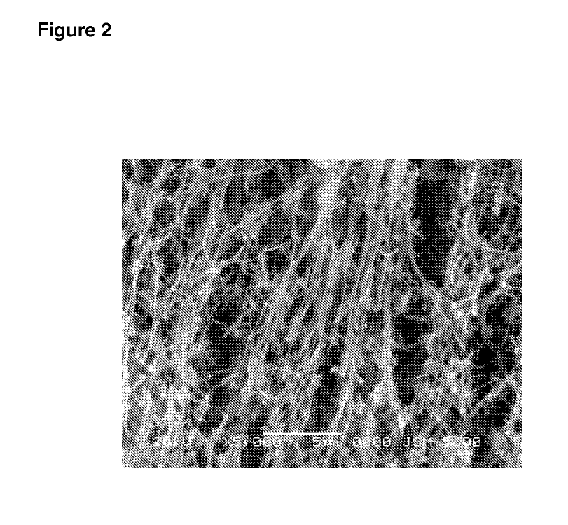

FIG. 2 showed SEM micrograph (5000×) of the surface of as received porous PTFE membrane. This micrograph showed that there were fibers with knots visible in the membrane and among the fibers and knots there were micro-pores in PTFE membranes.

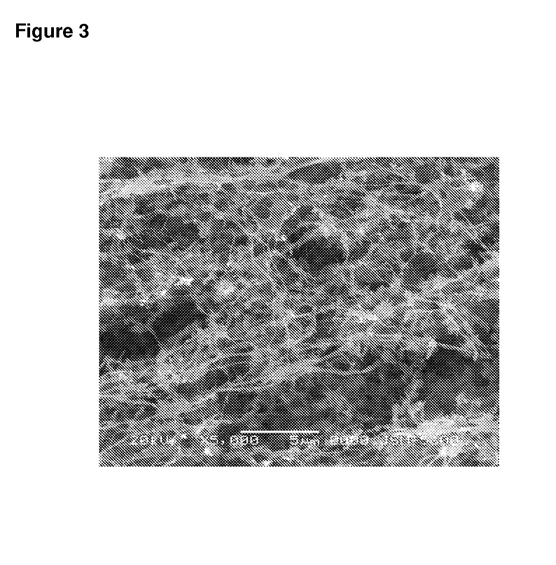

FIG. 3 showed the SEM micrograph (5000×) of the surface of PBI-PTFE-0 composite membrane, which was prepared by impregnating porous PFTE with PBI/DMAc/LiCl solution without pre-treating with a PFSI solution. As shown in FIG. 3, the PTFE membrane impregnated with a PBI solution without pre-treating with a PFSI coupling solution had PBI polymer coated on the surface of fibers and knots. The surface of the composite membrane had micro-pores and fiber-like structures visible in the micrograph. This result suggested that PBI was not compatible with PTFE and the bonding between PBI and PFTE was weak.

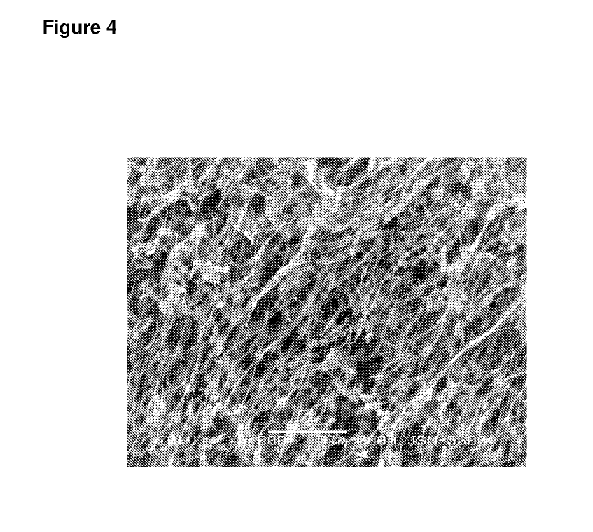

FIG. 4 showed the SEM micrograph of the surface of porous PTFE membrane after impregnated with a 0.7 wt % PFSI solution. A thin film of PFSI resin covered on the surface of fibers and knots of PTFE was visible.

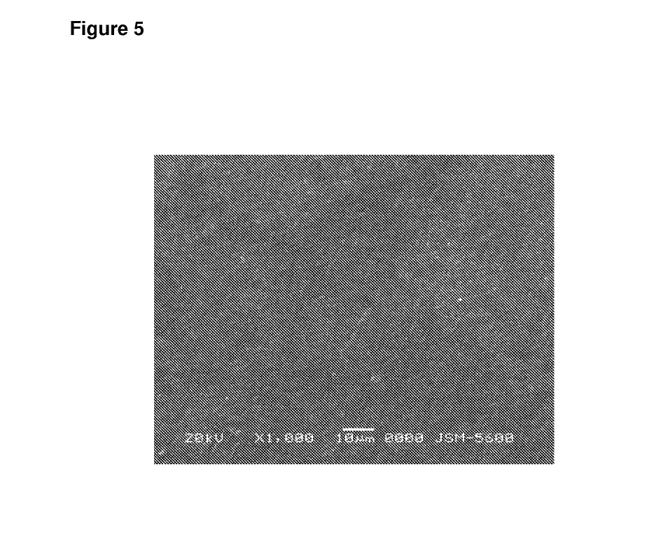

FIG. 5 showed the micrograph of the surface of PBI-PTFE-19 composite membrane (thickness=19 μm), which was prepared by immersion porous PTFE in a 0.7 wt % PFSI solution and then in a 4.5 wt % PBI/DMAc/LiCl solution. As shown in FIG. 5, all the micro-voids of PTFE membranes had been filled and completely covered with PBI. It was known that PFSI resin composes of perfluorocarbon (—CF₂—CF₂—) main chain, which was compatible with PTFE, and ether fluorocarbon sulfonic acid (—OCF₂—CF₂(CF₃)—OCF₂—CF₂—OSO₃H) side chains, which were compatible with PBI. The side chains —OSO₃H groups of PFSI might react with —NH groups of PBI and formed ionic bonds. Thus PFSI acted as a coupling agent of PBI and PTFE, and PBI was well bonded with PTFE after the surface of porous PTFE membrane was covered with a thin film of PFSI resin.

### Conductivity Measurements

The ionic conductivity (σ) was calculated from current resistance (R) by using an equation σ=l/(AR). Where A was the cross section area of a membrane for a resistance measurement and l the length for a resistance measurement, i.e. the thickness of the membrane. R was measured by using an ac impedance system (model SA1125B, Solartron Co, UK). A device capable of holding a membrane for R measurement was located between probes. The testing device with a membrane was kept in a thermo-state under a relative humidity of 95+% at 70° C. and 18+2% at 150° C. and 180° C. The membrane area for R measurement was 3.14 cm².

The conductivity σ and the resistance per unit area, r=l/σ, of Nafion-117, PBI-100, and PBI-PTFE-22 calculated from R are listed in Table 2. The data shown in Table 2 were the average values of three measurements and the standard deviations were around +5%. These data showed that PBI-100 and PBI-PFTE-22 had higher conductivity than Nafion-117 at 150° C.˜180° C. However, PBI and PBI-PTFE had lower conductivity than Nafion-117 at 70° C. Table 2 also showed conductivities of PBI-PTFE-17 and PBI-PTFE-22 were lower than those of PBI-80 and PBI-100, however, due to the lower thickness of PBI-PTFE composite membranes, PBI-PTFE composite membranes had a lower resistance r than PBI membranes.

TABLE 2
Conductivities σ and resistances per unit area r of membranes
RH 95 + 1% at 70° C.; and RH18 + 2% at 150° C. and 180° C.

| membrane | σ (10³ m²/S) | r (10² m²/S) |
|---|---|---|
| Nafion-117 | | |
| 150° C. | 1.03 | 17.0 |
| 180° C. | 1.62 | 10.8 |
| 70° C. | 14.2 | 1.23 |
| PBI-100 | | |
| 150° C. | 14.4 | 0.694 |
| 180° C. | 18.6 | 0.538 |
| PBI-80 | | |
| 70° C. | 2.30 | 3.48 |
| PBI-PTFE-22 | | |
| 150° C. | 4.76 | 0.462 |
| 180° C. | 7.54 | 0.292 |
| 70° C. | 1.60 | 1.38 |
| PBI-PTFE-17 | | |
| 70° C. | 1.45 | 1.17 |

### Gas Permeability Study

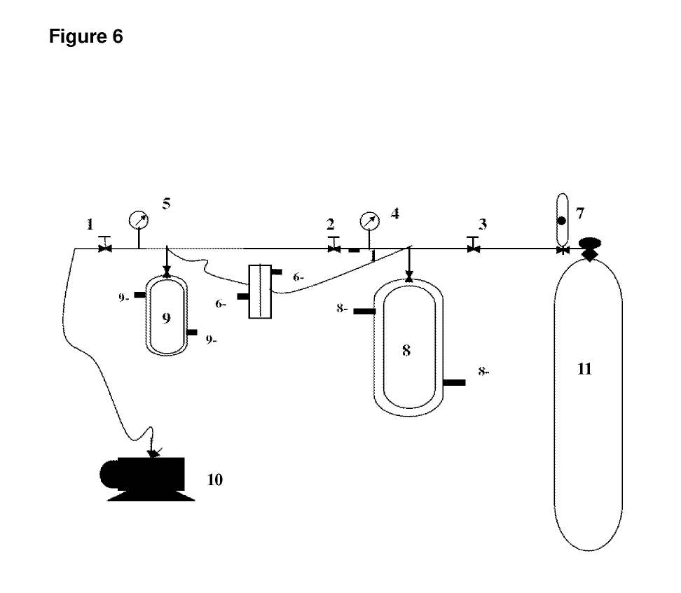

As illustrated by FIG. 6, gas permeability of membranes was investigated using an apparatus designed in our lab. A device of holding a membrane was located between two vessels, with the volume of vessel-1 of 3000 ml and that of vessel-2 of 200 ml. At the beginning of gas permeability test, vessel-1 was filled with N₂ gas under a pressure of 3 kgf/cm² and vessel-2 was kept under vacuum. The membrane holder was kept at a temperature of 25° C. The gas permeability of the membrane was characterized by measuring the pressure of vessel-2 (P₂) versus testing time. The time for the vessel-2 pressure P₂ to reach 0.03 kgf/cm² for each membrane was recorded. A membrane with a higher gas permeability (or poor gas barrier) should have a higher P₂ increment rate, i.e. a shorter time for P₂ to reach 0.03 kg/cm².

The gas permeability tests of PBI-PTFE-17, PBI-PTFE-19, PBI-PTFE-22, and PBI-100 membranes were shown in Table 3. The longer time for vessel-2 pressure to reach 0.03 kg/cm² the better the gas barrier property of the membrane. These data show the time for vessel-2 pressure P₂ to reach 0.03 kg/cm² decreased in the sequence: PBI-100>PBI-PTFE-22>PBI-PTFE-19>PBI-PTFE-17, indicating PBI-100 had the best gas barrier property in all of these membranes, because of highest film thickness. However, the time “118 hr” of P₂ of PBI-PTFE-22 to reach a pressure of 0.03 kg/cm² was close to that of PBI-100 suggested that PFSI was a good coupling agent of PBI and PTFE and improved the bonding force between PBI and PTFE.

TABLE 3
Gas permeation measurement -
the time for vessel-2 pressure P₂ = 0.03 kgf/cm²

| membrane | thickness of membrane (μm) | gas permeation time (hr) |
|---|---|---|
| PBI-100 | 100.0 | 124 |
| PBI-PTFE-17 | 15.0 | 76 |
| PBI-PTFE-19 | 19.0 | 81 |
| PBI-PTFE-22 | 22.0 | 118 |

### Fuel Cell Performance Tests

### PEMFC Performance Tests at 150° C. and 180° C.

The PBI and PBI-PTFE-22 composite membranes prepared in our lab were used to prepare membrane electrolyte assemblies (MEA). The catalyst was Pt—C (E-TEK, 20 wt % Pt) catalyst and the Pt loadings of anode and cathode were 0.5 mg/cm². Pt—C/PBI/DMAc (3.5/1/49 by wt) catalyst solution was prepared by ultrasonic disturbing for 5 hr. The catalyst solution was coated on a carbon cloth (E-TEK, HT 2500-W). Two carbon cloths coated with a catalyst layer were put on both sides of a membrane and pressed at 150° C. with a pressure of 50 kg/cm² for 5 min to obtain a MEA. The performances of single cells were tested at 150° C. and 180° C. by using a FC5100 fuel cell testing system (CHINO Inc., Japan). The anode H₂ input flow rate and the cathode O₂ input flow rate were 300 ml/min.

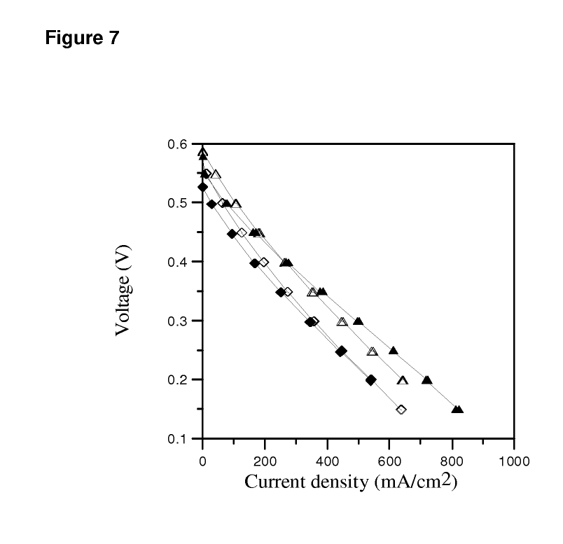

FIG. 7 showed the cell potential V versus current density i curves at 150° C. and 180° C. of single fuel cells prepared from PBI-100 and PBI-PTFE-22 composite membranes. Table 4 summarized PEMFC open circuit voltages of these two PEMFCs operated at 150° C. and 180° C.

TABLE 4
OCV data of PEMFC single cells operated at 150° C. and 180° C.

| Temp | 150° C. | 180° C. |
|---|---|---|
| PBI-100 | 0.573 V | 0.595 V |
| PBI-PTFE-22 | 0.532 V | 0.580 V |

The cell voltage at open circuit, i.e. the open circuit voltage (OCV), usually did not reach the theoretical value of the overall reversible cathode and anode potentials at the given pressure and temperature. The lowering of OCV from theoretical voltage had been attributed to the penetration of fuel across the membrane. The other reason for the low OCV values could be attributed to the poor hardware design of our flow channel plates, leakage of fuel happens during the operation of a fuel cell. Table 4 showed that for a same MEA, the OCV value increased with increasing operating temperature, due to the higher electro-chemical reaction rate at a higher temperature. However, at a fixed PEMFC operating temperature, the MEA prepared from PBI-PTFE-22 had a lower OCV value than that prepared from PBI-100, indicating a higher penetration of fuel across PBI-PTFE membrane than that of fuel across PBI membrane. The OCV data were quite consistent with gas permeation data shown in Table 3. In Table 3, we found that PBI-PTFE-22 had higher gas permeation than PBI-100, due to the lower thickness of PBI-PTFE-22 than PBI-100. As will be shown in the section of PEMFC performance tests at 70° C., we will found the OCV values of PEMFC operated at 70° C. (Table 4) were much higher than those of PEMFC operated at 150° C. and 180° C. The reason for the low OVC values of PEMFC operated at 150° C. and 180° C. could be attributed to the poor hardware design of flow channel plates, leakage of fuel happens during operation of a fuel cell. However, the main purpose of this experimental example was to compare the PEMFC performances of MEAs prepared from PBI and PBI-PTFE membranes. The poor hardware design would not affect the comparison results between MEAs prepared from PBI and PBI-PTFE membranes.

FIG. 7 showed the voltages of single fuel cells fall as current density increases. One of the reasons for the falling down of the voltage with increasing current density was the so called “ohmic loss” which comes from the resistance to the flow of ions through the polymer electrolyte membrane. It was found that though the PBI-PTFE-22 composite membrane had a lower ionic conductivity than PBI-100 membrane, however, owing to the thinner thickness of PBI-PTFE-22 than PBI-100, the PBI-PTFE-22 had a shorter pathway for transporting H⁺ ion. Thus MEA prepared from PBI-PTFE-22 composite membrane had a lower slope of voltage against current density while the current density i>200 mA/cm² and thus a lower “ohmic loss” than PBI membrane. These results were consistent with the “resistance” data shown in Table 2.

### PEMFC Performance Tests at 70° C.

The PBI-80 and PBI-PTFE-22 composite membranes were used to prepare membrane electrolyte assemblies (MEA). The catalyst was Pt—C (E-TEK, 40 wt % Pt) catalyst and the Pt loadings of anode and cathode were 0.5 mg/cm² and 1.0 mg/cm², respectively. Pt—C/PBI/DMAc (3.5/1/49 by wt) catalyst solution was prepared by ultrasonic disturbing for 5 hr. The catalyst solution was coated on a carbon cloth (E-TEK, HT 2500-W). Two carbon cloths coated with a catalyst layer were put on both sides of a membrane and pressed at 150° C. with a pressure of 50 kg/cm² for 5 min to obtain a MEA. The performances of single cells were tested at 70° C. by using a Globe Tech Computer GT (Electrochem Inc) fuel cell testing system. The anode H₂ input flow rate and the cathode O₂ input flow rate were 200 ml/min.

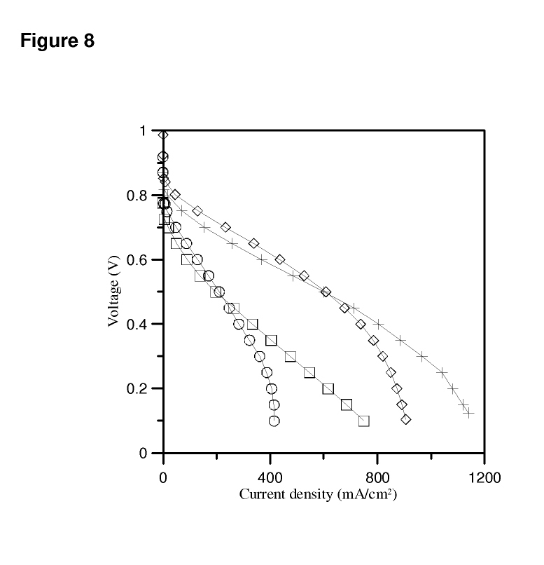

FIG. 8 showed the cell potential V versus current density i curves of single fuel cells prepared from Nafion-117, PBI-80, PBI-PTFE-22, and PBI-PTFE-17 membranes. Table 4 summarized PEMFC open circuit voltages of these PEMFCs operated at 70° C. These data showed OCV value decreased with decreasing membrane thickness.

TABLE 4
OCV data of PEMFC single cells operated at 70° C.

| membrane | OCV (V) |
|---|---|
| PBI-80 | 0.91 |
| PBI-PTFE-22 | 0.89 |
| PBI-PTFE-17 | 0.79 |
| Nafion-117 | 0.98 |

FIG. 8 showed the voltages of single fuel cells fall as current density increases. It was found that though the PBI-PTFE-22 and PBI-PTFE-17 composite membranes had lower ionic conductivities than PBI-80 membrane, however, owing to the thinner thickness of composite membranes, the PBI-PTFE-22 and PBI-PTFE-17 had a better PEMFC performance than PBI-80. The experimental results also showed that PBI-PTFE-22 had similar PEMFC performance as Nafion-117.

In this invention, we showed PFSI resin was an excellent coupling agent for PTFE and poly(benzimidazole) (PBI), which containing —NH groups. Using PFSI as a coupling agent of PBI and porous PTFE, we successfully prepared PBI-PTFE composite membranes. The PBI-PTFE-22 composite membrane had a film thickness of ˜22 μm and thus a lower proton resistance than a PBI membrane with a film thickness of 80˜100 μm. Because of higher mechanical strength of PTFE than PBI, for fuel cells applications, the thickness of PBI-PTFE composite membranes was allowed to be lower than that of pure PBI membranes. The PEMFC single cell tests showed that PBI-PTFE-22 composite membranes had a better performance than PBI-100 membranes at 150˜180° C., because of thinner thickness and thus lower resistance of PBI-PTFE-22.

One skilled in the art readily appreciates that the present invention is well adapted to carry out the objects and obtain the ends and advantages mentioned, as well as those inherent therein. The processes and methods for measuring antibiotic resistant organism are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method for preparing of a proton exchange composite membrane with low resistance, the method comprises:
(a) providing a fluorocarbon based polymer membrane having porous structure and a coupling agent consisting of fluorocarbon backbone and an acidic functional group, wherein the fluorocarbon backbone is compatible with the membrane and the acidic functional group is compatible with a polymer containing a basic functional group; and
(b) treating the membrane with the coupling agent to form a thin film of the coupling agent on the porous structure of the membrane.

2. The method of claim 1, which further comprises:
(c) treating the membrane prepared by step (b) with the polymer containing a basic functional group.

3. The method of claim 2, which further comprises
(d) immersing the membrane prepared by step (c) in an acidic solution to increase ionic conductivity.

4. The method of claim 3, wherein the acidic solution is sulfuric acid or phosphoric acid.

5. The method of claim 1, wherein the membrane is immersed in acetone before the treatment.

6. The method of claim 1, wherein the polymer containing basic functional groups is a non-fluorocarbon based polymer.

7. The method of claim 6, wherein the basic functional group is —NH, —NH₂ or —OH group.

8. The method of claim 6, wherein the polymer is polyamide, polyimide, chitosan, or polybenzimidazole.

9. The method of claim 1, wherein the membrane is made of poly(tetrafluoroethylene).

10. The method of claim 1, wherein the treatment is by immersion, screen printing, spin coating, brushing, or coating with a film applicator.

11. A proton exchange composite membrane with low resistance which comprises:
(a) a fluorocarbon based polymer membrane having porous structure as a supporting material; and
(b) a coupling agent consisting of fluorocarbon backbone and an acidic functional group, wherein the fluorocarbon backbone is compatible with the membrane and the acidic functional group is compatible with a polymer containing a basic functional group.

12. The membrane of claim 11, which further comprises:
(c) the polymer with basic functional groups.

13. The membrane of claim 11, which is prepared according to the method of claim 1.

14. The membrane of claim 11, wherein the polymer containing basic functional group is a non-fluorocarbon based polymer resin.

15. The membrane of claim 14, wherein the basic functional group is —NH, —NH₂ or —OH group.

16. The membrane of claim 14, wherein the resin is polyamide, polyimide, chitosan, or polybenzimidazole.

17. The membrane of claim 11, which has between 15 and 30 μm in thickness.

18. The membrane of claim 12, which can be applied to fuel cell or electrolytic reaction.

19. A coupling agent which consists of a fluorocarbon backbone and acidic functional groups, wherein the fluorocarbon backbone is compatible with a fluorocarbon based polymer membrane having porous structure and the acidic functional group is compatible with a polymer containing a basic functional group.

20. The coupling agent of claim 19, which is perfluorosulfonate resin or perfluorocarbonate resin.

21. The coupling agent of claim 19, wherein the polymer containing basic functional group is a non-fluorocarbon based polymer resin.

22. The coupling agent of claim 21, wherein the non-fluorocarbon based polymer is polyamide, polyimide, chitosan or polybenzimidazole.

23. The coupling agent of claim 19, wherein the membrane is made of poly(tetrafluoroethylene).

24. The coupling agent of claim 19, wherein the acidic functional group is —SO₃H or —COOH group.
